(19) United States
(12) Patent Application Publication
(10) Pub. No.: US 2010/0063935 A1
(43) Pub. Date: Mar. 11, 2010

(54) Multi-Factor Authorization System and Method

(75) Inventors: Ajit Thomas, San Francisco, CA (US); Rodney Robinson, Los Altos Hills, CA (US); John Michael Tumminaro, Mountain View, CA (US); John Tumminaro, Palo Alto, CA (US)

Correspondence Address: Law Offices of James E. Eakin, P.O. Box 1250, Menlo Park, CA, 94026, US

(73) Assignee: Obopay, Inc., Redwood City, CA (US)

(21) Appl. No.: 12/555,772

(22) Filed: Sep. 8, 2009

Related U.S. Application Data
(63) Continuation of application No. 11/694,747, filed on Mar. 30, 2007.
Application No. 11/694,747 is a continuation of application No. 12/470,482, filed on May 21, 2009.
(60) Provisional application No. 61/095,290, filed on Sep. 8, 2008.

(51) Int. Cl. G06Q 10/00

(52) U.S. Cl. 705/325

(57) ABSTRACT

Method and system for authenticating the identity of a party to a transaction being executing over wired or wireless networks, using a personal device. A transaction system is adapted to receive messages over a network from a connected device, where the messages are intended to initiate a transaction. The system comprises authentication rules and an associated engine for identifying the type of transaction and, for each type of transaction, whether MFA is required. If so, the necessary MFA attributes are requested, thus permitting completion of the transaction in a comparatively secure manner and also permitting management of the accounts associated with the party.

### RELATED APPLICATIONS

The present application is related to, and claims the benefit under 35 USC Section 119 of, U.S. provisional Patent Application Ser. No. 61/095,290, filed Sep. 8, 2008, entitled Multi-Factor Authorization System and Method, as well as U.S. patent application Ser. No. 11/694,747, filed Mar. 30, 2007, entitled Mobile Person-to-Person Payment System, and U.S. patent application Ser. No. 12/470,482, filed May 21, 2009, entitled Mobile Person-to-Person Payment System, all of which are incorporated herein by reference.

### FIELD OF THE INVENTION

This application relates generally to methods and techniques for authenticating the identity of a party to a transaction, and more particularly relates to methods and techniques for authenticating the identity of a person executing a transaction over wired or wireless networks, using a personal device. This invention applies throughout the lifecycle of either or both the transaction and the associated accounts.

### BACKGROUND OF THE INVENTION

One difficulty in managing accounts and conducting financial transactions via electronic networks is the challenge of verifying that the person conducting the transaction is actually authorized to perform the transaction in question. The difficulty of authenticating the identity of a person conducting such a transaction has led to the proposal of many different sorts of authentication and verification techniques, most of which offer limited utility, particularly for transactions conducted over a wireless network, such as transactions conducted from a mobile phone.

Thus, there has been a long-felt need for methods and techniques for efficiently and reliably authenticating the identity of those transacting network-based business.

### SUMMARY OF THE INVENTION

The present invention provides a configurable system and methods for implementing multi-factor authentication (“MFA”) for protection of transactions and customer information when transactions are being conducted through any of a variety of channels, utilizing a consumer personal computing device, communicating through data networks such as the Internet, or proprietary networks, utilizing such transport mechanism as voice communication services, broadband data services, wireless data services, SMS, AIM or other instant messaging services, over such protocols as TCP/IP, or proprietary data transport protocols.

The implementations associated with each channel check for “something the user knows, and something the user has” to maintain and verify the authenticity of the user and therefore to secure private information and transaction capability. Such authentication methods can include the verification of: a PIN or Passcode; the phone number, serial number, secure element ID associated with the mobile device or personal portable device used in the transaction; the IP address of the data connection; the geographical location of the IP address; the geographical location of the portable device as determined by the network it is connected to or by a Global Positionning System functionality; the name of the account holder as registered by a third party service provider. The portable computing device can be equipped with a client software or widgets utilizing such programming technology as J2ME, BREW or other equivalent technology; and can access on-line data and services such as mobile internet pages or WAP enabled web pages, or IVR enabled services.

In an embodiment, the system of the present invention includes authentication rules and a configuration engine to identify which authentication rules need to be applied for various transactions and activities, depending on the stage of the life cycle of the associated accounts, on the financial risk associated with the transaction or activity, and the access channel used to complete the transaction or activity.

In an embodiment, the system of the present invention can include a plurality of repositories storing information used in completing a multi-factor authentication, where such repositories are associated with systems to identify a personal computing device; or with systems to identify a network connection service (such as a broadband or wireless service); or with systems to store the name and address of a person participating in a transaction; or with the systems for managing a communications network.

In another embodiment, the system of the present invention includes an authentication processing engine used to complete authentication rules processing; to address authentication requests to the plurality of repositories used to store authentication information; and to determine the result of the authentication process based on the conjoint or sequential analysis of the result of each individual authentication request.

In an embodiment, the system and technique of the present invention can be used to secure the registration and/or activation of a new service account; the transfer of moneys or financial assets; the payment of goods and services; the cancellation or closure of an account; the completion of a customer service request such as a balance inquiry, a service inquiry, or a service upgrade. Those skilled in the art will recognize that such multi-factor authentication methods, system and technique can be used on a variety of transactions performed over networks and carrying a certain financial risk if the participants were not uniquely identified and authenticated.

In an embodiment, the techniques of the present invention are used to provide secure enrollment in a service using, as one example, a J2ME-enabled handset. In such an embodiment, data is collected, including input by the user of a PIN (personal identification number, although the PIN can be any character string and not just numbers). Then, depending upon the version of J2ME supported by the handset, either a “push” SMS or a manual SMS is sent to the handset. If a “push” SMS, a verification is managed automatically; when a “push” SMS is not available, transmission of an SMS message with a verification code followed by the user's manual entry of that verification code permits completion of the MFA process.

In a similar manner, MFA processes using BREW, WAP, SMS and web-based platforms are provided in accordance with the invention. In connection with payment or money transfer transactions, instances in which MFA procedures are appropriate comprise the foregoing sign-up process, and also various user processes including sending of funds (whether user-initiated or in response to a “send money” request from a third party), loading a prepaid account, login using an unregistered device [i.e., a device different than the user's known and validated device(s)], and a one-time pickup of funds. In part, the MFA process ensures that, for appropriate transactions, for example those in which money is sent, the sending user not only knows a secret such as a PIN or a Passcode, but also has physical possession of the device, such as a handset, being used to initiate and confirm the transaction.

### THE FIGURES

FIG. 1 illustrates the general architecture of multi-factor authentication in accordance with the present invention.

FIG. 2 illustrates in logic flow diagram form an embodiment of an MFA process in accordance with the invention.

FIG. 3 illustrates in logic flow diagram from an embodiment of an MFA process using WAP in accordance with the invention.

FIG. 4 illustrates in flow diagram form an overview of an embodiment for managing transactions involving multi-factor authentication with callbacks.

FIG. 5 illustrates in logic flow diagram form an MFA process performed at the transaction level using WAP/SMS.

FIG. 6 illustrates in a high level diagram the steps to implement MFA for various channels and platforms, in accordance with the foregoing Figures.

FIG. 7 illustrates an embodiment of a Multi-factor Authentication Configurations and Rules Engine.

### DETAILED DESCRIPTION OF THE INVENTION

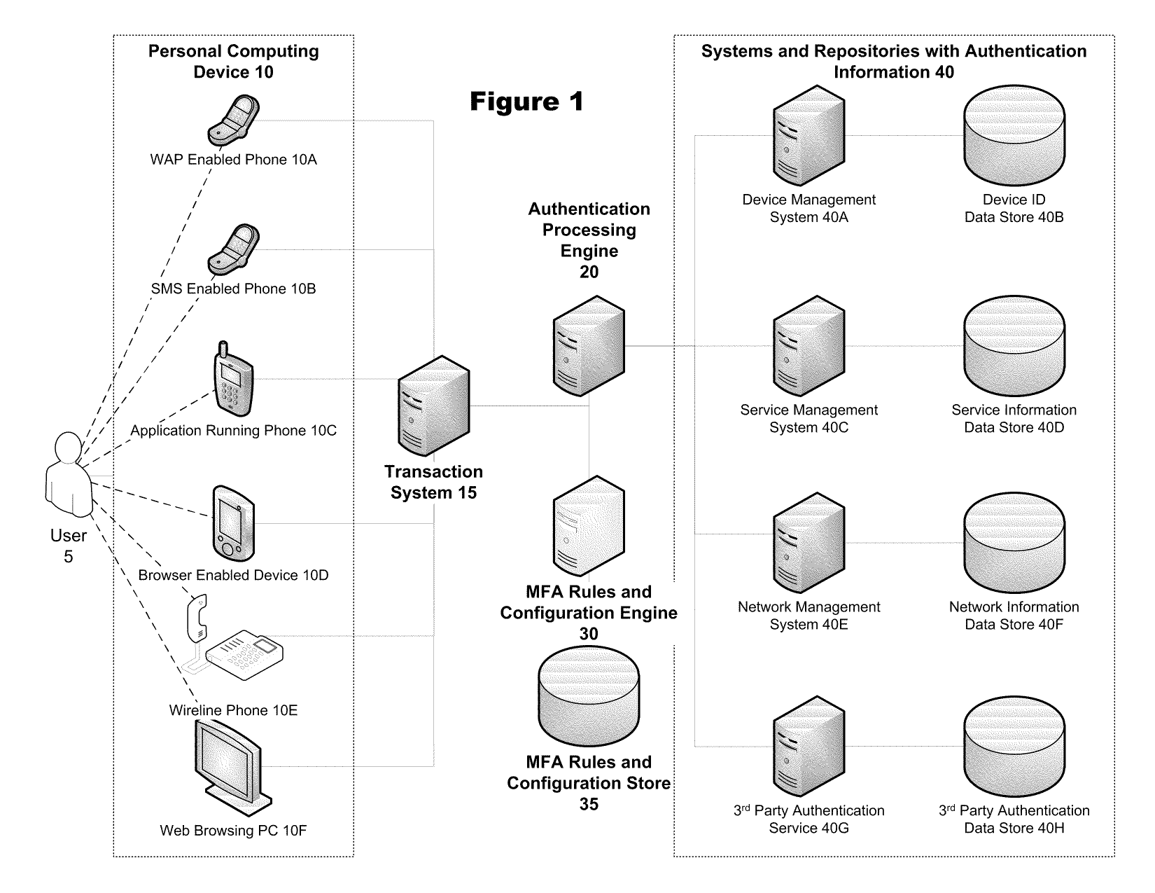

Referring first to FIG. 1, there is shown therein an embodiment of a multi-factor authentication system identifying the various architectural elements involved in completing a Multi-factor authentication request. User 5 accesses a Transaction System 15 through a Personal Computing Device 10 to obtain a service. The Personal Computing Device can be a mobile phone capable of SMS communications, or capable of browsing mobile internet pages, or capable of executing applications; or a personal device capable of browsing the internet for instance using a WiFi connection to an Internet connected access point; or a regular phone used to access a automated voice response system or an operator; or a Personal computer capable of browsing the internet, executing local applications or executing widgets. Transaction System 15 inquires from the Multi-factor Authentication Configurations and Rules Engine 30 the type of authentication required in order to secure the transaction.

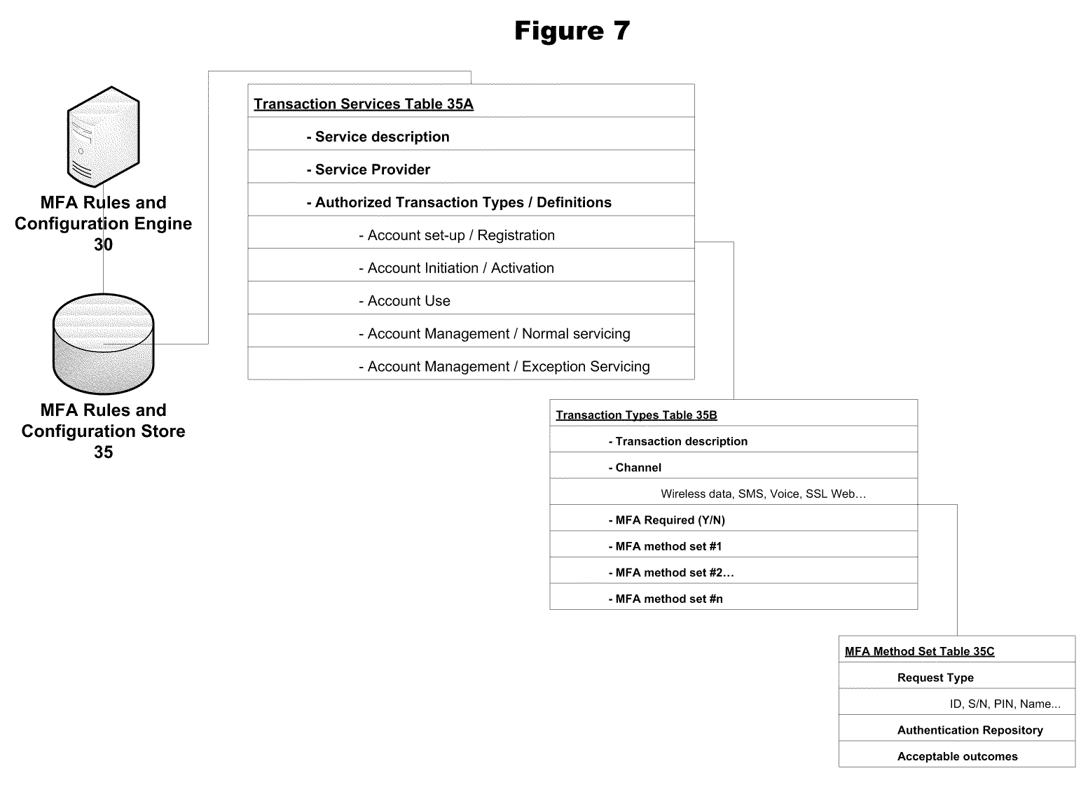

The MFA Configurations and Rules Engine 30 accesses the MFA Rules and Configuration Store 35 where the information to process the authentication processed is stored. FIG. 7, discussed hereinafter, illustrates examples if transaction services 35A, transaction types 35B, and method sets 35C. Upon selection of the proper authentication requirement, the Transaction System 15, interfaces with the Authentication Processing Engine 20, to complete the authentication process. The Authentication Processing Engine 020 sends authentication requests to the various Systems and Repositories 40A-40H which can comprise authentication information system and repositories 40. Such systems and repositories 40A-40H can include the service management system 40C of either the transaction provider, and/or the mobile service provider, and/or a financial services provider; as well as the system 40A managing the Personal Computing Devices deployed in the field; or the system 40E managing the network through which the Personal Computing Device is accessing the service for which the transaction is performed; or the third party authentication service 40G and associated data store 40H. Each Repository responds to the authentication request with any query to the User 5 or Personal Computing Device 10 necessary to authentication such user or device. Upon receiving a response the Repository 40 validates the identity of user 5 or the device and provides the Authentication Processing Engine 20 with a response to the authentication request.

The sequence described here above is illustrative only and a person skilled in the art will recognize that the communications between the various systems of the present invention can be implemented in a number of ways, such that the foregoing description is not intended to be limiting. Rather, the present invention is to be limited only by the appended claims. Likewise, those skilled in the art will recognize that the functionalities of the various systems can all be incorporated into a single server or distributed across multiple servers. Likewise, the repositories and data stores can reside in a single database, or multiple databases in a single repository, or can be distributed across multiple databases and multiple repositories.

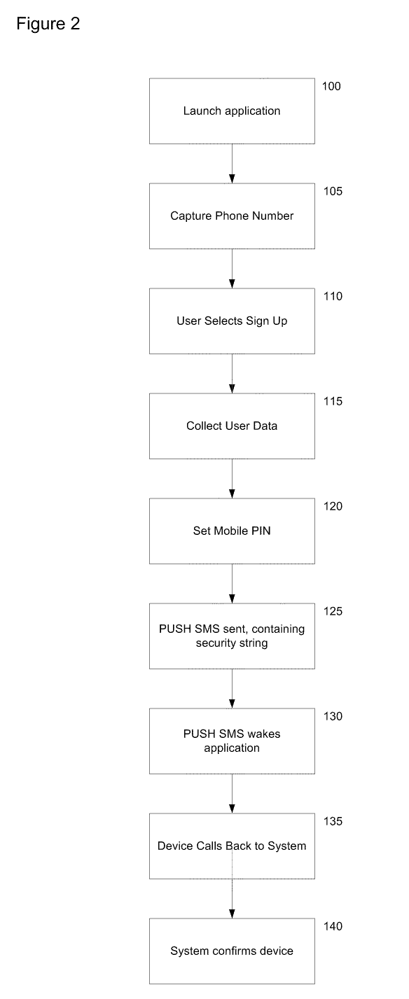

Referring next to FIG. 2, an embodiment of an MFA process is illustrated in the context of user sign-up. Although the present invention encompasses the use of various platforms and personal computing device technology (including J2ME, BREW, WAP, and so on), for purposes of clarity the embodiment illustrated in FIG. 2 involves a J2ME platform, otherwise known as Java ME or a mobile and embedded Java platform.

As noted above, the illustrated process is for user-signup from such a handset, and starts at step 100 with the launching of an application resident on the handset. The application can be preloaded on the handset by the manufacturer, downloaded by the user or carrier, or installed on the handset in any convenient manner. Following launch of the application by the user, at step 105 the phone number of the handset is pulled from the device to the system of the present invention, such as that described in U.S. patent application Ser. No. 11/694,747, filed Mar. 30, 2007, entitled Mobile Person-to-Person Payment System, or U.S. patent application Ser. No. 12/470,482, filed May 21, 2009, having the same time, both of which are commonly assigned and incorporated herein by reference. The application can, in some embodiments, require that the user enter the phone number, although in other embodiments the phone number can be automatically retrieved from the device. In addition, in most embodiments the phone number is communicated to the system in a secure manner.

Following capture of the phone number, which in other embodiments could alternatively be any other indicia unique to the device or the user, the application offers the user the opportunity to sign up, or register, with the system. The user then selects “Sign Up”, as shown at step 110, after which appropriate user data is collected as shown at step 115. Depending upon the device and the nature of the data appropriate for the particular embodiment, the user can be required to enter the user data or, if the data resides in the device at an accessible location, the application can capture and transmit the user data to the system. Then, at step 120, the user selects and enters a PIN or PassCode. In an embodiment, the PIN or PassCode can comprise a multi-character string, for example six numerals, or a series of hex numerals, or any other string of characters understandable by the system. The PIN or PassCode is transmitted to and stored in the system, typically in encrypted form, and then, as shown at step 125, the system transmits a “push” SMS message to the phone number captured at step 105. The SMS message typically comprises at least a security string.

In MIDP (Mobile Information Device Profile) 2.0 devices or similarly capable devices, the pushed SMS “wakes up” the application as shown at 130, and the application then calls, sends back a message, or otherwise communicates the security string or other confirming indicia to the system, as shown at 135. The successful exchange of communications confirms the device, as shown at step 140. It will be appreciated that other steps, not important to the invention, have been omitted for clarity. Such steps can include, for example, requiring the user to accept various contractual provisions, terms and conditions.

In other embodiments, such as those implemented on MIDP 1.0 J2ME devices or similarly capable devices, a manual SMS message is transmitted from the system to the device at step 125, rather than the “push” SMS shown in FIG. 2. In such an arrangement, the manual SMS comprises at least a security string, which the user is then prompted to enter. The security string entered by the user is transmitted to the system, permitting confirmation of the device in substantially the same manner as shown in FIG. 2.

In an embodiment, a similar process is used for login where the user's device has not been registered, for example, first time login from the wireless device where sign-up occurred on a different channel, or where there is some other reason to require authentication. In an embodiment for such a process, the user launches the application as shown in FIG. 2, and the user selects “log in” instead of “sign up” at step 110. For MIDP 2.0 J2ME devices, the process of FIG. 2 proceeds substantially as shown, including the use of a “push” SMS with a security string, followed by automatic waking of the application and transmission back to the system. As with signup, the process for MIDP 1.0 J2ME devices is also similar in at least some embodiments, where the user is sent a manual SMS message with a security string, and the user must enter the security string to permit authentication to complete.

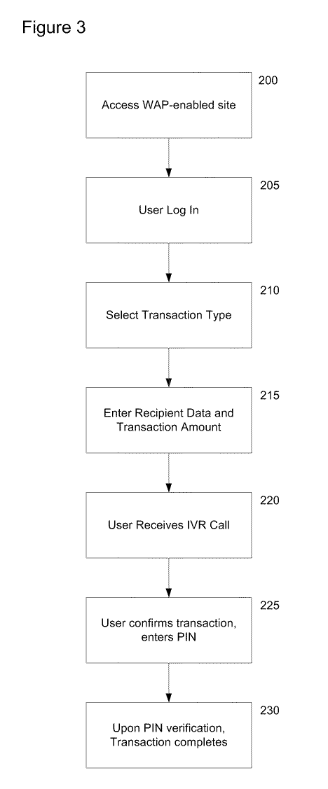

Transactions involving the WAP protocol can, in some embodiments of the invention, involve an IVR callback, as shown in FIG. 3. The process starts with the user accessing a WAP-enabled website, as shown at 200. The user then logs in, typically by providing a unique indicia such as their phone number together with their PIN, as shown at 205. The system presents the user with one or more transaction types, and the user selects the appropriate one as shown at 210. The user then enters the recipient's, together with the transaction amount, as shown at 215, and this information is transmitted to the system. The system then initiates an IVR call to the user's device, shown at 220. Depending upon the particular embodiment, a text-to-speech system can be used to convert the user's spoken word into data, or keypad entries can be used, but in either event the user is prompted to confirm the transaction, typically by confirming the transaction amount together with re-entering their PIN, as shown at 225. Once the confirmation is verified, the transaction completes as shown at 230.

Other types of transactions can be performed using a WAP protocol with IVR callback, including loading (“adding funds to”) a prepaid card or account using either a credit card or a bank account (including ACH transfers), or the purchase of an item, or a response to a request for money from a third party. As with the process illustrated in FIG. 2, for purposes of clarity the process illustrated in FIG. 3 omits steps not important to an understanding of the invention, including, for example, a verification that sufficient funds are available, or offering the user alternative funding sources, and so on.

In systems using the SMS protocol for transactions, MFA verifications can be performed in a manner similar to that shown in FIG. 3. In an embodiment of such a process, the user sends a message to a pre-defined number comprising the “send” command, the recipient's identification, and the transaction amount. Thereafter, the system initiates an IVR call to the user, who confirms the transaction as with the WAP process described above. Once the confirmation data is verified, the transaction completes. Other transactions, including “requests for money”, “accept money”, and “get money”, can all be handled in a substantially similar manner, where the key elements are the indicia unique to the transaction, followed by an IVR call to confirm at least some of those details, with the transaction completing once the confirmation data is verified. It will be appreciated that the confirmation occurs substantially instantaneously, making the confirmation process user friendly while maintaining near-real-time operation of the present system.

In addition, the MFA process of the present invention can be used for viral transactions, or transactions in which a recipient of funds is not otherwise registered with the system. In such an arrangement, the unregistered user accesses the system via any convenient channel, such as the web, and selects a “pick up money” transaction. The user then enters appropriate personal information to verify identify, along with information identifying where their funds should be sent, such as an account at a financial institution, a check mailed to their address, or other disposition. The system communicates to the user's device a temporary PIN, and then calls the device. The user enters the temporary PIN, permitting the system to complete the transaction.

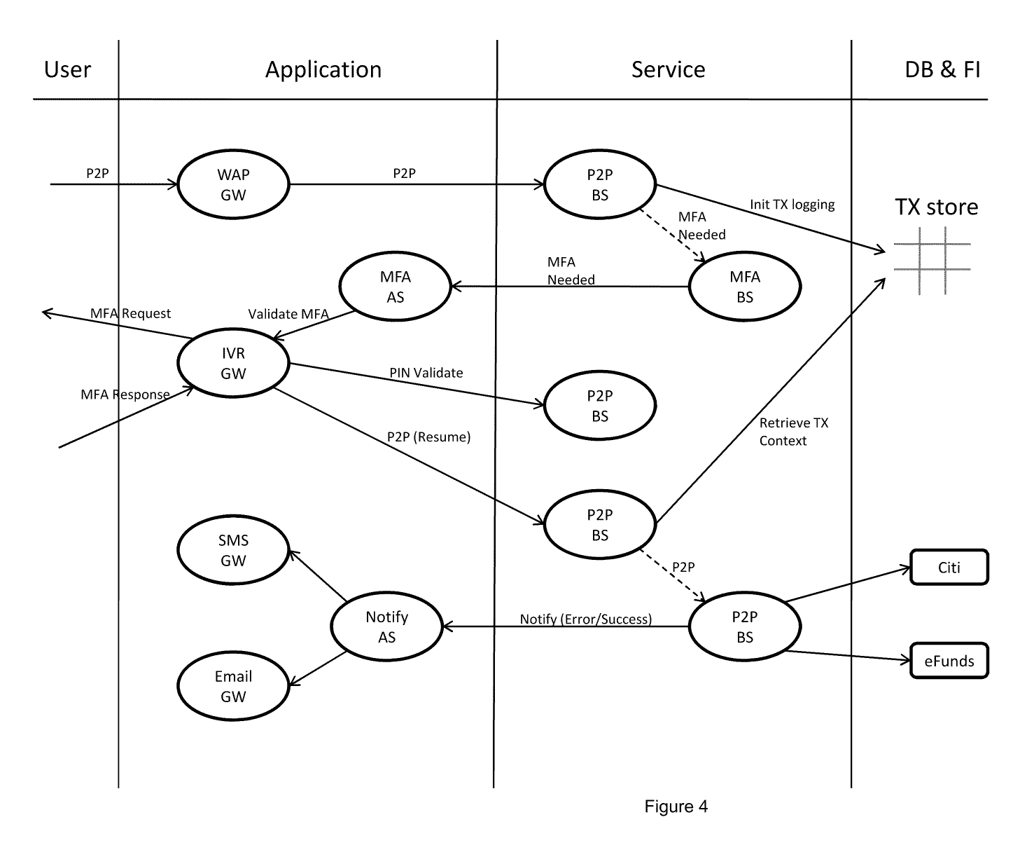

Referring next to FIG. 4, an overview of an embodiment for managing transactions involving multi-factor authentication with callbacks is illustrated in process flow form. Steps indicated with a dashed line occur asynchronously. The services provided by system applications are indicated as AS, while business services are indicated as BS. It will be appreciated that the embodiment of the MFA “callback” itself can be facilitated via any number of protocols/channels/identities such as SMS, IVR, email, IM, etc.

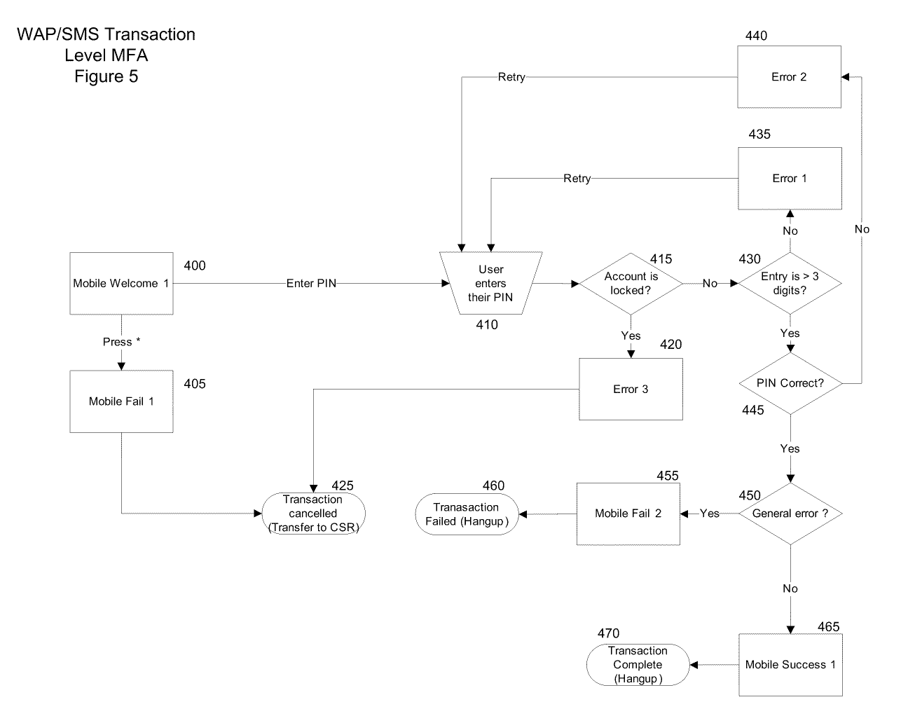

Referring next to FIG. 5, the phone confirmation IVR process can be better appreciated. When the user answers the IVR call, a welcome message is played, displayed or otherwise communicated as shown 400. If the user enters a key not permitted in their PIN, or otherwise fails to proceed properly, the call terminates at Mobile Fail 1, shown at 405. However, if the user begins entry of a PIN, a check is made at 415 to determine whether their account is locked. If it is, an error occurs at step 420 and the transaction cancels at step 425.

If the account is not locked, the process advances to step 430, where a check is made to see whether the PIN entered by the user has an appropriate number of digits. If not, an error is indicated at 435, and the process loops to 410, after which the user is permitted to enter their PIN again. If the user makes repeated PIN entry errors, the account is locked and the transaction cancels at 425. If the user enters a proper number of digits, but still the wrong PIN, an error is noted at 440 and the user is invited to reenter their PIN. In some embodiments, lock-out occurs immediately where the number of characters is too few, whereas multiple tries are permitted before lockout where the number of digits is closer to correct.

However, in most cases the PIN is correct, and the process advances to step 445. A general error can still occurs, as noted at 450, resulting in a hang-up as shown at 455 and 460. However, where the PIN is correct and no other failure occurs, the process advances to step 465 and the transaction completes at 470, including a hangup.

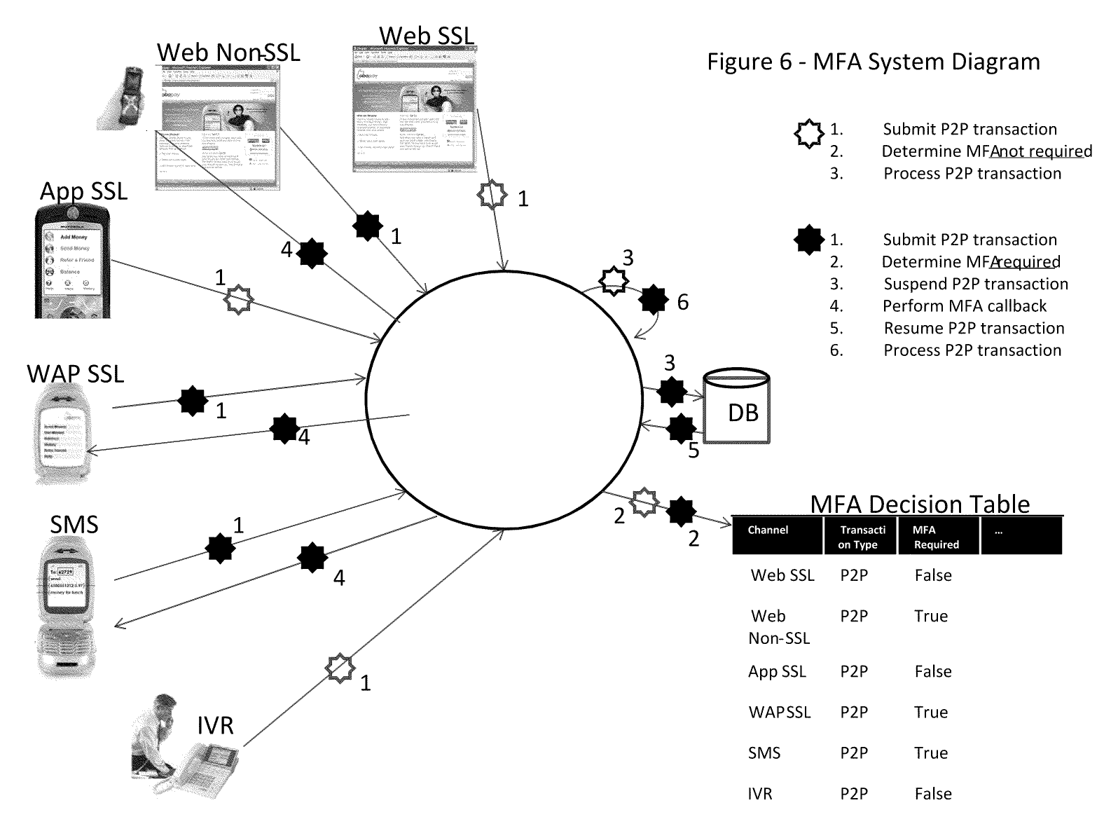

Next, FIG. 6 depicts an embodiment of the system of the present invention where the service access is for Person to Person money transfer, across a variety of channels, for which different authentication rules are required. Referring to FIG. 6, the types of channels where MFA is not required is indicated by a hollow star, whereas channels where MFA are required are indicated by a solid star. In addition, the need to perform MFA using an IVR call is shown by the suspend-resume process shown in the steps at the upper right of FIG. 6. It will also be appreciated that IVR is available as an independent channel for performing MFA.

Referring to FIG. 7, an embodiment of the Multi-factor Authentication Configurations and Rules Engine 30 is illustrated. It is understood that the MFA Configurations and Rules Engine 030 and Associated MFA Rules and Configurations Stores 035 is composed of one or a plurality of servers and associated databases, that are located and managed either by a transactional service provider or by a third party authentication provider contracted by such transactional service provider to provide high assurance authentication services. In a typical arrangement, the third party authentication provider provides such MFA services to a plurality of transactional service providers. The MFA Configuration and Rules Engine 030 utilizes a set of tables or data structures describing, for each service, the type of transaction included in the service delivery. An exemplary embodiment is shown in FIG. 7 as Transaction Service Table 035A, together with tables or data structures, an exemplary embodiment of which is the Transaction Table Types Table 035B, which describe the rules associated with each transaction types. Included among such rules is whether a Multi-Factor Authentication needs to be performed, and the sets of equivalent authentications which must be completed. In an embodiment, the authentication methods required are described in a set of tables or data structures, such as shown by MFA Method Set Table 035C, identifying the participating repository, the type of authentication performed, and the acceptable outcome of the authentication. Examples of Transaction Services that can utilize the present invention include information services such as specialized weather services (sailing, flying . . . ), stock and financial market tickers, sports tickers . . . ; Top-Up services for prepaid utilities; Account to Account money transfers; Person-to-Person money transfers and remittances; Bill payment services and merchant account payment services; Non-public information transfer services (such as health information, identity information); or any services the utilization of which gives rise to a series of transaction with registered and un-registered users, for which the actual or potential financial and legal liabilities require that certain degrees of authentication be performed to manage the risks associated with the transactions.

Examples of Transaction Types for each of the Services supported include all aspects of the management of the lifecycle of a transaction or an account, including the initial registration for the service; the activation of the account and the delivery of the first transaction; the normal use of the account and the service; the servicing of the account through activities such as balance inquiries, account information updates, statements, etc . . . ; and the servicing of the account in exception situations such as a reversal of a transaction, the blocking of an account, the closure of an account, etc . . .

Examples of MFA methods include PIN or Passcode validation; identity validation such as name, address, social security number, drivers license number; serial number of the device or a secure element contained in the device; phone number or IP address associated with the device; location of the Personal Computing Device at the time of the transaction, etc . . . Authentications may include a query to the user of the service, a call back or message back to validate the origin of the transaction, a query to the Personal Computing Device, and/or a query to a 3^{rd} party provider holding information associated with the identity of the user or of the Personal Computing Device.

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

We claim:

1. A method for authenticating the identity of a party to a transaction being executed over wired or wireless networks, using a personal device, comprising the steps of
receiving, over a network, a message to initiate one of a plurality of transactions,
identifying at least one indicia of the device transmitting the message,
identifying the type of transaction, where at least one of the plurality of transactions requires further authentication and at least another one of the plurality of transactions does not,
applying a set of rules appropriate to the transaction,
for transactions requiring further authentication, comparing the party's response to predetermined acceptable responses, and
accepting or rejecting the transaction request depending upon the outcome of the comparison.

2. A system for authenticating the identity of a party to a transaction comprising
a transaction engine for receiving messages requesting that a transaction be initiated, and identifying the type of transaction being requested,
at least one repository for storing sets of rules for authenticating a party depending upon the type of transaction requested, and
a rules engine for identifying a set of rules applicable to the requested transaction and applying the applicable rules.
